(19) United States
(12) Patent Application Publication
(10) Pub. No.: US 2022/0331895 A1
(43) Pub. Date: Oct. 20, 2022

(54) METHOD FOR CUTTING TENSIONED TENSIONING MEMBERS OF A CONCRETE TOWER, CUTTING DEVICE FOR CUTTING TENSIONED TENSIONING MEMBERS OF A CONCRETE TOWER, AND USE OF A CUTTING DEVICE

(71) Applicant: Wobben Properties GmbH, Aurich (DE)

(72) Inventors: Johann HARMS, Ihlow (DE); Thomas IHNEN, Holtgast (DE); Holger SAATHOFF, Esens (DE)

(21) Appl. No.: 17/619,552

(22) PCT Filed: Jun. 12, 2020
(86) PCT No.: PCT/EP2020/066262

§ 371 Date: Dec. 15, 2021

(30) Foreign Application Priority Data
Jun. 21, 2019 (DE) 10 2019 116 840.6

(51) Int. Cl. B23K 7/00; E04H 12/12; E04H 12/16; F03D 13/20

(52) U.S. Cl. CPC B23K 7/005; E04H 12/12; E04H 12/16; F03D 13/20; F05B 2230/70; F05B 2240/912

(57) ABSTRACT

A method for cutting tensioned tension members of a concrete tower, in particular of a wind power installation concrete tower, which has a multiplicity of tension members, said method comprising coupling a bar-shaped positioning element to a main frame; positioning the positioning element in such a manner that the cut end thereof that faces the concrete tower is disposed within a cutting region in the interior of the concrete tower, wherein at least one of the tension members is situated within the cutting region; disposing a cutting unit on the cut end of the positioning element; positioning the cut end in such a manner that the cutting unit has a predetermined spacing from one of the tension members; cutting the tension member with the cutting unit.

### BACKGROUND

### Technical Field

The invention relates to a method for cutting tensioned tension members of a concrete tower, in particular of a wind power installation concrete tower, to a cutting device for cutting tensioned tension members of a concrete tower, in particular of a wind power installation concrete tower, and to the use of a cutting device.

### Description of the Related Art

Wind power installations are known. The currently most widely used type of a wind power installation is the so-called horizontal-axis wind power installation, which is usually equipped with three rotor blades, whereby wind power installations having one, two, four or more rotor blades are also possible. A wind power installation comprises a rotor which as a result of an airflow moves in a rotational manner and by way of a rotor drives a generator, wherein the generator is generally disposed within a nacelle. The nacelle is preferably disposed on a tower which is configured either as a steel tower or as a concrete tower. A concrete tower is in particular a tower which is largely made from concrete, whereby portions may however also be produced from another material, preferably steel. A tower of this type preferably has a tubular geometry, whereby the diameter of the tower decreases along the longitudinal extent of said tower toward the nacelle.

Concrete towers for wind power installations are typically produced from reinforced concrete. Concrete towers made of reinforced concrete are distinguished by an additional longitudinal force which is typically applied by tensioned steel inserts. The concrete of the concrete tower is impinged with a compressive force as a result of the longitudinal force. The steel inserts can be configured as tension members, for example. The tension members can extend from a base of the concrete tower to a top of the concrete tower. Moreover, the tension members can also extend in portions within the concrete tower.

It may be necessary for concrete towers to be deconstructed under certain circumstances. The deconstruction is required in the context of repowering and in the case of concrete towers at risk of collapse, for example. The deconstruction of concrete towers is however associated with a plurality of difficulties, the safety of participating personnel and the high complexity being disadvantageous in particular. The existing methods for deconstructing concrete towers and systems for carrying out methods of this type offer various advantages, but further improvements are however desirable.

The German patent and trademark office in the course of the priority application pertaining to the present application has searched the following prior art: DE 10 2016 113 224 B3, DE 2 246 093 A, EP 2 339 094 A1, U.S. Pat. No. 5,469,677 A, DE 10 2016 113 227 B3.

### BRIEF SUMMARY

Provided is a method for cutting tensioned tension members of a concrete tower, in particular of a wind power installation concrete tower, a cutting device for cutting tensioned tension members of a concrete tower, in particular of a wind power installation concrete tower, and the use of a cutting device which mitigate or eliminate one or a plurality of the disadvantages mentioned. Provided are one or more techniques that enable the safe and/or cost-effective deconstruction of a concrete tower. Provided are one or more techniques that enable a safe deconstruction of a concrete tower at risk of collapse.

Provided is a method for cutting tensioned tension members of a concrete tower, in particular of a wind power installation concrete tower, which has a plurality of tension members, said method comprising coupling a bar-shaped positioning element to a main frame, positioning the positioning element in such a manner that the cut end thereof that faces the concrete tower is disposed within a cutting region in the interior of the concrete tower, wherein at least one of the tension members is situated within the cutting region, disposing a cutter on the cut end of the positioning element, positioning the cut end in such a manner that the cutter has a predetermined spacing from one of the tension members, cutting the tension member with the cutter.

The tension members to be cut are preferably present as external tension members in the concrete tower. External tension members are in particular tension members of a type accessible from the interior of the concrete tower. These external tension members differ from internal tension members in that the internal tension members are disposed within the wall of the concrete tower or within casing tubes. Furthermore preferably, the tension members to be cut can also comprise internal tension members or be present as the latter.

Tension members are also referred to as stranded tension wires. A plurality of tension members are typically combined so as to form a tension unit. The tension members combined so as to form a tension unit are in most instances coupled to the concrete tower by way of an upper tensioning anchor at the upper end of said tension members and by way of a lower tensioning anchor at the lower end of said tension members.

The cutting region is at least partially situated in the interior of the concrete tower. Portions of the cutting region may also be disposed outside the concrete tower. The cutting region is preferably disposed completely in the interior of the concrete tower. The cutting region is preferably sized in such a manner that the cutter for cutting, by means of the bar-shaped positioning element, can be completely inserted within the cutting region. The main frame preferably serves as a mounting for the bar-shaped positioning element. For this purpose, the bar-shaped positioning element is coupled to the main frame.

The coupling of the bar-shaped positioning element to the main frame is preferably configured in such a manner that the bar-shaped positioning element can be moved within the cutting region, the cutter furthermore preferably being able to move within the cutting region. This means in particular that the bar-shaped positioning element is coupled to the main frame so as to be movable in the longitudinal direction of said positioning element. It is moreover preferable that the bar-shaped positioning element is rotatably coupled to the main frame. The design embodiment of the coupling of the bar-shaped positioning element to the main frame can be variously configured, as will be explained in more detail hereunder.

The main frame can have one, two or a plurality of main frame portions. The two or a plurality of main frame portions can be mutually separate or be connected to one another. For example, a first main frame portion can be disposed within the tower, and a second main frame portion can be disposed outside the tower. The first main frame portion and the second main frame portion can be disposed so as to be separate from one another. The first main frame portion and the second main frame portion are preferably coupled to one another, preferably connected to one another.

The positioning element has the cut end that is disposed in the cutting region. The positioning element preferably extends from the cut end toward an operating end. In order to be operated by an operator, the operating end of the positioning element preferably faces away from the cutting region. The extent of the positioning element between the cut end and the operating end is preferably chosen in such a manner that the operating end protrudes from the concrete tower such that operating is possible outside the concrete tower. The positioning element is configured in a bar-shaped manner. Bar-shaped means in particular that this is an elongate element, the direction of main extent thereof being greater than the cross-sectional dimensions orthogonal to the direction of main extent by a multiple. The positioning element can have one, two or a plurality of bar-shaped elements which are furthermore preferably disposed in parallel and/or in sequence.

The cutter is disposed on the positioning element at the cut end, or in a portion adjacent to the cut end, respectively. The cutter is preferably configured for cutting tension members of a concrete tower. As will be explained in more detail hereunder, the cutter can be configured as a flame cutter or as a subtractive tool, for example, or comprise either of the latter. The cutter is disposed within the cutting region in such a manner that cutting of the tension members, or of a tension member, respectively, with the cutter is possible. To this end, the cutter is positioned in such a manner that the latter has a predetermined spacing from one of the tension members. The predetermined spacing is preferably selected as a function of the cutter used. For example, a cutter configured as a flame cutter is preferably positioned at less than 5 cm, less than 3 cm, or less than 2 cm, from the stranded tension wire to be cut. Furthermore preferably, the cutter configured as a flame cutter is positioned in such a manner that a burner flame impinges the stranded tension wire at an angle of 45 degrees.

The cutting of the tension member is performed with the cutter. The cutting of the tension member with the cutter preferably takes place once the cutter has been positioned. The cutting of the tension member can also comprise the, preferably simultaneous, cutting of two or a plurality of tension members. For example, in the case of tension members combined so as to form a tension unit, wherein the tension members have a minor mutual spacing or substantially no mutual spacing, the cutting of an individual tension member may also have the effect of at least partially cutting one, two or a plurality of further tension members. The cutter is preferably disposed in such a manner that two or a plurality of tension members are simultaneously cut.

The abovementioned steps of the method for cutting tensioned tension members of the concrete tower can be carried out in a substantially arbitrary sequence. The coupling of the bar-shaped positioning element to the main frame and the disposing of the cutter on the positioning element are preferably carried out as preparatory measures. The main frame, as a preassembled device including the positioning element and the cutter, can be moved to the concrete tower so as to thereon carry out the method for cutting tensioned tension members of the concrete tower. The cutting of the tension member with the cutting unit preferably takes place once the cutter has been positioned in such a manner that the latter has a predetermined spacing from one of the tension members. The main frame has furthermore preferably been positioned prior to the cutter being positioned and the tension member being cut with the cutter.

The disclosure is based inter alia on the concept that the cutting of tensioned tension members of a concrete tower is associated with risks. The tension members are typically tensioned by a force of several kilonewtons. When the tension members are being cut, the cut tension member relaxes abruptly and typically in such a manner that the latter performs unpredictable movements in the interior of the tower and thus represents a safety risk to personnel located in the tower.

The disclosure is furthermore based on the concept that the cutting of tensioned tension members of a concrete tower can also be performed without personnel being located in the interior of the concrete tower. To this end, it is proposed that the main frame is provided within the concrete tower and within a cutting region such that, by means of the bar-shaped positioning element, a cutter can be disposed on a tension member to be cut.

The disclosure is moreover based on the concept that concrete towers which are at risk of collapse and have tensioned tension members can be demolished only with significant safety risks. The method proposed above enables the dismantlement of concrete towers at risk of collapse with tensioned tension members without any personnel having to enter the concrete tower. Furthermore, the proposed method enables a cost-effective possibility for deconstructing a concrete tower.

The method described above moreover offers the possibility for said method to be adapted to different method situations. Concrete towers, in particular concrete towers of wind power installations, have different configurations; for example, the installation conditions of the tension members differ. As a result of the proposed method, different installation conditions of tension members within the concrete tower, and moreover also different access conditions, for example as a result of access of variable configuration to the concrete tower, can however be managed individually.

In one preferred variant of embodiment of the method it is provided that the main frame is disposed outside the concrete tower, or the main frame is disposed completely or partially within the concrete tower. When the main frame is disposed outside the concrete tower, entering the tower by an operator, for example, is not required when carrying out the method for cutting tensioned tension members. As a result, the cutting of tensioned tension members is enabled in particular when access to the tower is impossible and/or impermissible. In this case it is particularly preferable for the cutter to be configured as a flame cutter or to comprise the latter, said flame cutter to be described in more detail hereunder. When the main frame is disposed partially or completely within the tower, it is possible for the cutter to be better positioned relative to a tension member. In the case of the main frame being disposed within the tower, it is preferable for the cutter to be configured as a subtractive tool or to comprise the latter, said subtractive tool still to be described in more detail hereunder.

In one preferred variant of embodiment of the method it is provided that the positioning element extends from the cutting region to an operating region which is preferably situated outside the tower.

The operating region is preferably the region or portion where an operator can operate the bar-shaped positioning element. This region or portion is preferably disposed outside the tower so that the operator of the bar-shaped positioning element can act outside the tower.

According to a further preferred variant of embodiment of the method it is provided that said method comprises the step of disposing a processing carriage on the main frame, wherein the processing carriage is disposed so as to be movable on the main frame, the positioning element by means of the processing carriage is coupled to the main frame, and wherein the positioning element in a relocation direction of the processing carriage is preferably fixedly disposed on the processing carriage.

The processing carriage preferably acts as a coupling element between the main frame and the positioning element. The coupling of the processing carriage to the main frame is preferably configured in such a manner that the main frame has a rail on which the processing carriage is guided. This guide is in particular configured in such a manner that the processing carriage falling off the main frame is avoided or impeded. The positioning element in a relocation direction of the processing carriage is preferably fixedly disposed on the processing carriage. The relocation direction of the processing carriage is preferably directed in the longitudinal direction of the main frame. As a result of a disposal of this type, the positioning element can be operated from an end that faces away from the cutting region and be relocated on the main frame by means of the processing carriage. Consequently, the end of the positioning element that faces the cutting region can be moved within the cutting region. The cutter disposed on this end can thus be moved within the cutting region, and the predetermined spacing from a tension member can be set.

It is furthermore preferable that the main frame has a guide rail, and the processing carriage has two guiding elements, in particular wheels, that are disposed on an axle, wherein the spacing of the insides of the guiding elements, in particular the insides of the wheels, is greater than a width of the guide rail.

It can moreover be preferable that the processing carriage has substantially vertically aligned legs, the guide rail of the main frame being able to be disposed therebetween. Moreover, these legs can extend in an angular manner from the remaining part of the processing carriage such that guiding takes place on the guide rail.

Alternatively or additionally to the processing carriage, the positioning element can be otherwise coupled to the main frame. For example, the main frame can have a guide sleeve, wherein the positioning element is disposed so as to be displaceable within the guide sleeve. Moreover, the positioning element can be configured so as to be deployable. The deployable positioning element can be coupled to the main frame either in a fixed or displaceable manner.

A further preferred refinement of the method is distinguished in that the cutter is configured as a flame cutter or comprises the latter, at least one gas supply element, preferably a gas-conducting hose, is disposed on the flame cutter, and the gas supply element is preferably fastened to the positioning element, preferably in a releasable manner.

A flame cutter is in particular understood to be a tool for flame cutting. Flame cutting is in particular a cutting method by way of which metallic materials are cut, in that a flame heats the material on the surface to an ignition temperature and combusts said material by supplying oxygen. The combustion heat released in turn heats the underlying material layers to the ignition temperature such that the process propagates in a self-acting manner into the depth of the material. The liquid slag created is blown out by the cutting oxygen.

At least one gas supply element is disposed on the flame cutter. The gas supply element on the end thereof that faces away from the flame cutter is preferably coupled to a gas tank. The gas required for the cutting process from the gas tank is preferably conveyed to the flame cutter by way of the gas supply element. This is preferably performed in that the gas is stored under pressure in the gas tank. An adjustable valve for regulating the gas flow into the flame cutter is preferably situated between the flame cutter and the gas tank. The valve can also be part of the flame cutter, wherein the valve is preferably disposed ahead of an exit nozzle of the flame cutter.

It is preferable that the flame cutter by means of a first gas supply element is supplied a first gas, and by means of a second gas supply element is supplied a second gas. The first gas is preferably a combustion gas/oxygen mixture. The second gas is preferably oxygen.

One preferred refinement of the method provides that the cutter is configured as a subtractive tool or comprises the latter, and the cutter by way of a tool receptacle is preferably disposed on the positioning element. The subtractive tool can be an angle cutter or an angle grinder, for example. The angle grinder can be equipped with a roughing disk. Moreover, the subtractive tool can be a cutting tool, for example pliers, scissors, or a cutting press. The pliers can be configured as hydraulic pliers, for example, and the scissors can be configured as hydraulic scissors. The subtractive tool can be fixed to the tension member to be cut, for example.

In one preferred variant of embodiment of the method it is provided that the tension members by way of the member ends thereof, in a region of the concrete tower that faces away from the tower base, are fixed by means of an anchor plate, wherein the anchor plate has vertically aligned passage openings, and wherein the member ends by means of chock elements are disposed in the passage openings in such a manner that said member ends are fixed in the direction of the tower base, the method comprising disposing a cover unit above the passage openings, and fastening the cover unit to the anchor plate.

The disclosure is furthermore based on the concept that the tension members when cutting tension members of a concrete tower perform uncontrolled movements also in the tower head. As a result of the tension member relaxing as a consequence of cutting, the ends of the tension members that face the tower head slide out of the anchoring. The anchoring is typically performed with an anchor plate. The anchor plate has a number of passage openings, in particular tension member openings, for tension members, a number of said passage openings corresponding to the number of tension members of one tension unit. The ends of the tension members that face the tower head are fixed in the passage openings by means of chock elements. The chock elements however fix the tension members substantially in a direction that faces the tower base. The chock elements preferably do not substantially fix the tension members in the opposite direction. However, when the tension members as a result of cutting have a force in the direction of the tower head, said tension members jump out of the anchor plate. For this purpose, this variant of embodiment provides the disposal of the cover unit above the passage openings. A vertical movement of the tension members in the direction of the tower head is prevented as a result of the cover unit fastened to the anchor plate.

A further preferred refinement of the method is distinguished in that the cover unit has a first cover element having a first cover plate, wherein a bridging element is disposed on the first cover plate in such a manner that an available height exists between the first cover plate and the bridging element, and the first cover plate has a first plate flank and a second plate flank, wherein the bridging element is disposed between the first plate flank and the second plate flank, and a second cover plate is disposed on the first plate flank, and a third cover plate is disposed on the second plate flank, the second cover plate and the third cover plate are connected to the first cover plate, the second cover plate and the third cover plate are preferably connected by means of a fourth cover plate that from the second cover plate extends through the available height to the third cover plate.

A cover unit configured in such a manner enables the efficient and above all also reliable covering of the passage openings. The cover unit configured in such a manner can be efficiently produced and be fastened to the anchor plate in the tower head with great temporal efficiency by an operator.

It is moreover preferable that the fastening of the cover unit to the anchor plate comprises incorporating at least one opening and incorporating a thread in this opening, wherein the cover unit by means of at least one screw is fastened to the anchor plate.

The incorporation of the opening is preferably performed by a drilling method. To this end, a magnetic drilling machine is preferably disposed on the anchor plate or in a region adjacent to the anchor plate and operated by means of a vertical guide. The incorporation of the thread is preferably performed by a tapping method.

It is furthermore preferably provided that the operating region is situated in an operating space closed on at least three sides, and the operating space is preferably configured as a container, wherein that side of the container that faces the concrete tower is furthermore preferably at least partially closed.

The operating space is preferably different from the interior space of the concrete tower. For example, a gas tank, furthermore preferably two or more gas tanks, can be disposed in the operating space. The main frame preferably extends from the cutting region to the operating region, wherein one, two or more gas supply elements extend from the cutter to the operating region and/or the operating space. The operating space preferably has a first lateral wall and a second lateral wall disposed so as to be plane-parallel to the former, wherein the two lateral walls are connected to a roof. The two lateral walls are furthermore preferably connected to a floor. It is moreover preferable that the sides not closed by the lateral walls and/or the roof and/or the floor are configured so as to be able to be closed. To this end, these open sides can have closing elements, for example doors.

The operating space is preferably configured as a container. The container is preferably configured as a container with two doors, also referred to as a double-door container. The double-door container has two parallel lateral walls, a roof and a floor, wherein the remaining sides are able to be closed by doors. Such a container is preferable for carrying out the method because the devices and elements required for the method are able to be transported in said container and the latter can thus be efficiently utilized for the method. Furthermore, the safety of personnel participating in the method can be further enhanced by a container of this type of configuration.

In one preferred variant of embodiment of the method it is provided that the gas supplied to the flame cutter is disposed in at least one gas storage unit, and at least one gas storage unit is situated within the operating region, preferably within the operating space, preferably within the container. The gas storage unit is in particular to be understood to be a gas tank.

According to a further aspect, provided is a method for releasing the tension of tensioned tension members of a concrete tower, in particular of a wind power installation concrete tower, said concrete tower having a plurality of tension members which in a region of the concrete tower proximal to the tower base, in particular in a cellar, by way of an anchoring unit are anchored in the direction of a tower head, said method comprising: disposing a cutter, in particular a flame cutter, in a cutting region, wherein the anchoring unit is situated within the cutting region, and releasing the anchoring by means of the cutter. It is particularly preferable that the releasing of the anchoring is performed by burning and/or melting the anchoring unit, this preferably being performed with the flame cutter. This method is particularly preferably used for internal tension members that are disposed in casing tubes.

According to a further aspect, provided is a cutting device for cutting tensioned tension members of a concrete tower, in particular of a wind power installation concrete tower, comprising a main frame which extends from a processing end to an operating end, wherein the processing end is able to be disposed within a concrete tower, in particular within a wind power installation concrete tower, and the operating end is able to be disposed outside a concrete tower, in particular outside a wind power installation concrete tower, preferably within an operating region that is spaced apart from the concrete tower, a bar-shaped positioning element which is coupled to the main frame, and a cutter which is disposed on an end of the positioning element that faces away from the operating end of the main frame.

In one preferred variant of embodiment of the cutting device it is provided that said cutting device comprises a processing carriage which is disposed on the main frame and is preferably guided at least in one portion adjacent to the operating end, and wherein the positioning element in a relocation direction of the processing carriage is fixedly disposed on the processing carriage.

A further preferred refinement of the cutting device is distinguished in that the main frame has a guide rail and the processing carriage has two first guiding elements, in particular wheels, that are disposed on a first axle, wherein the spacing of the insides of the guiding elements, in particular the insides of the wheels, is greater than a width of the guide rail, and the processing carriage by way of the axle bears on the guide rail. It is moreover preferable that the processing carriage has two second guiding elements, in particular wheels, that are disposed on a second axle.

In one further preferred refinement of the cutting device it is provided that the cutter is configured as a flame cutter, and at least one gas supply element, preferably a gas-conducting hose, is preferably disposed on the flame cutter, and the gas supply element is furthermore preferably fastened to the positioning element, preferably in a releasable manner. Moreover, the cutter can be configured as a subtractive tool. The cutter by way of a tool receptacle can be disposed on the positioning element.

According to a further aspect, provided is the use of a cutting device according to at least one of the variants of embodiment described above for cutting tensioned tension members of a concrete tower, in particular of a wind power installation concrete tower of a wind power installation.

The cutting device described above and the use of a cutting device as well as the potential refinements thereof comprise features or method steps, respectively, which render said cutting device particularly suitable for use with the method described for cutting tensioned tension members of a concrete tower and the refinements of said method. In terms of further advantages, variants of embodiment and details of the embodiments pertaining to these further aspects and the potential refinements thereof, reference is also made to the previous description pertaining to corresponding method steps, features and refinements of the method for cutting tensioned tension members of a concrete tower.

### BRIEF DESCRIPTION OF THE SEVERAL VIEWS OF THE DRAWINGS

Preferred exemplary embodiments will be explained in an exemplary manner by means of the appended figures in which:

FIG. 1 shows a schematic three-dimensional view of an exemplary embodiment of a wind power installation;

FIG. 2 shows a schematic three-dimensional view of a construction for carrying out a method for cutting tensioned tension members of a concrete tower;

FIGS. 3a, 3b show schematic two-dimensional views of exemplary embodiments of a cutting device;

FIG. 4 shows a detailed view of the cutting device shown in FIG. 3a;

FIG. 5 shows a schematic three-dimensional view of an anchor plate having a plurality of tension members fastened thereto;

FIG. 6 shows a schematic three-dimensional view of a cover element;

FIG. 7 shows a schematic three-dimensional view of an anchor plate having a cover unit and a transportation element;

FIG. 8 shows a schematic two-dimensional view of a cable head disposed in the cellar of a concrete tower; and

FIG. 9 shows a schematic method for cutting tensioned tension members of a concrete tower.

In the figures, identical elements or elements with substantially identical or equivalent functions are identified by the same reference signs.

### DETAILED DESCRIPTION

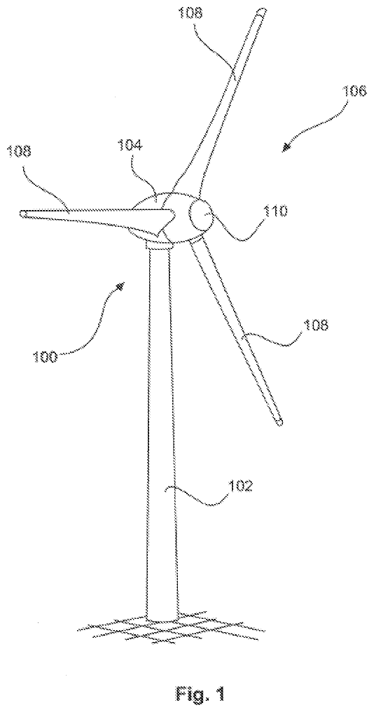

FIG. 1 shows a schematic three-dimensional view of an exemplary embodiment of a wind power installation 100. FIG. 1 shows a wind power installation 100 having a tower 102 and a nacelle 104. A rotor 106 having three rotor blades 108 and a spinner 110 is disposed on the nacelle 104. The rotor 106 when in operation is set in rotation by the wind and as a result drives a generator in the nacelle 104. The wind power installation 100 may be the subject matter of deconstruction, the latter being able to be carried out or facilitated, respectively, by a method described hereunder and a corresponding cutting device.

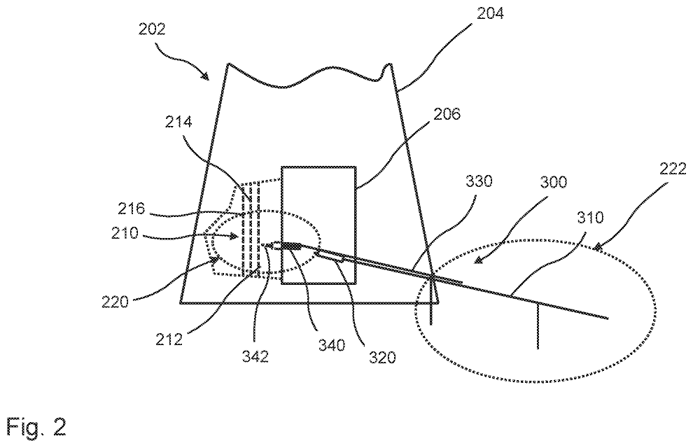

FIG. 2 shows a schematic three-dimensional view of a construction for carrying out a method for cutting tensioned tension members of a concrete tower. The concrete tower 202 has a tower wall 204. A tower opening 206 which is configured as an entry into the tower 202, for example, and can be closed by a door, for example, is disposed in the tower wall 204. The tower wall to the left of the tower opening 206 is shown in a cut-away illustration so that the interior of the tower 202 is shown. A plurality of tension units 210 for implementing reinforced concrete are disposed so as to be accessible from the interior of the tower 202. Each tension unit 210 comprises a plurality of tension members. The tension unit 210 in the present schematic illustration of FIG. 2 comprises a first tension member 212, a second tension member 214 and a third tension member 216. The tension members 212, 214, 216 preferably extend across substantially the entire longitudinal extent of the tower 202. Furthermore, the tension members 212, 214, 216 can extend across a portion of the longitudinal extent of the tower 202. The tension members 212, 214, 216 in the region of the tower base shown here and in the region of the tower head not shown here are preferably fastened by means of an anchor plate.

In order for the tower 202 to be deconstructed, it is inter alia necessary for the tension members 212, 214, 216 to be cut. The cutting of the tension members 212, 214, 216 by personnel using a side cutter or a flame cutter directly on the tension unit 210 is not a practical option because the highly tensioned tension members 212, 214, 216 when being cut, and as a result of the energy released herewith, perform unpredictable movements. These unpredictable movements can represent a safety risk for personnel within the tower 202.

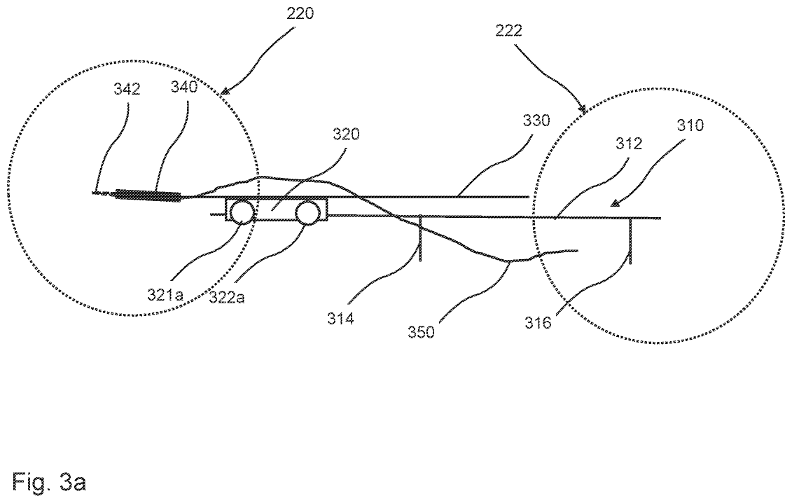

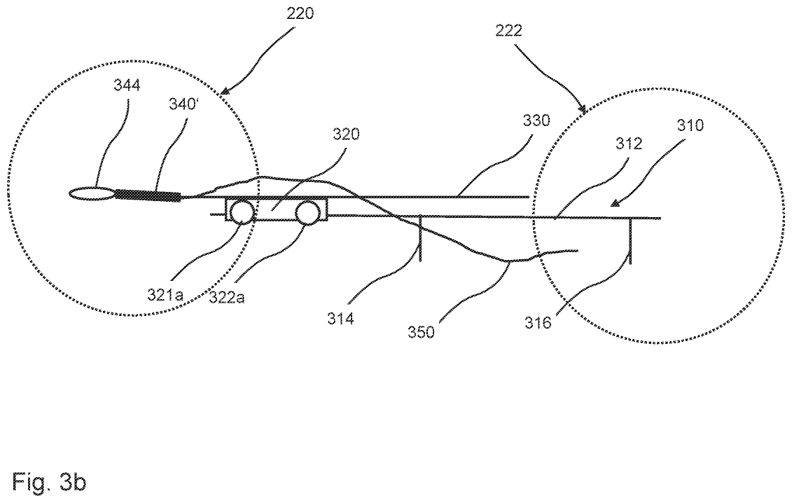

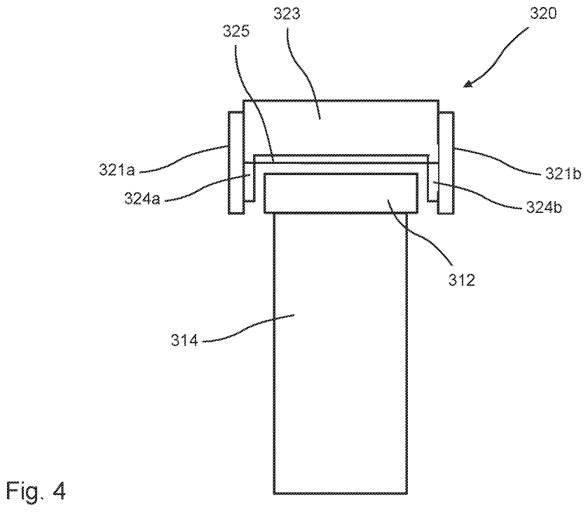

In order for the deconstruction of the tower 202 to be enabled nevertheless, a cutting device 300 is disposed. The cutting device 300 has the main components including a main frame 310, a positioning element 330 and a cutter 340. The main frame 310 is disposed within a cutting region 220. The bar-shaped positioning element 330 is coupled to the main frame. The coupling between the main frame 310 and the bar-shaped positioning element 330 takes place by a processing carriage 320. The processing carriage 320 shown in more detail in FIGS. 3a, 3b has a main body on which a front first wheel 321a and a rear second wheel 322a are disposed. Wheels are likewise disposed on that side of the wheels 321a, 322a that lies opposite in FIGS. 3a, 3b. The processing carriage 320 is disposed on a guide rail 312 of the main frame 310. The guide rail 312 can be seen in particular in FIG. 4. Moreover, the guiding of the processing carriage 320 by the guide rail 312 is shown in FIG. 4. The guide rail has a horizontal extent which is smaller than an internal horizontal extent of the main body 323 of the guide carriage 320. A left leg 324a and a right leg 324b extend vertically downward from the main body 323. An axle 325 extends through the legs 324a, 324b. The axle 325 serves for attaching the left first wheel 321a and the right first wheel 321b.

The positioning element 330 is preferably fixedly disposed on the carriage 320 shown in FIGS. 3a and 3b. The positioning element 330 in the relocation direction of the carriage 320 is in particular fixedly disposed on the guide carriage 320. The positioning element 330 is preferably mounted so as to be pivotable about an axis that is aligned so as to be orthogonal to the drawing plane.

The cutter 340 is disposed on that end of the positioning element 330 that faces the cutting region 220, wherein the cutter 340 in FIG. 3a is configured as a flame cutter, the flame cutter having a burner flame 342. The cutter 340′ in FIG. 3b is configured as an angle grinder which has a roughing disk 344.

The main frame 310 extends from an end that is disposed in the cutting region 220 to an end that is disposed in an operating region 222. A gas supply element 350 is disposed on the cutter 340. The gas supply element 350 extends along the main frame 310 to the operating region 222 in which at least one gas storage unit which is not shown and supplies the cutter 340 with gas is disposed. The main frame 310 next to the guide rail 312 has a first frame support 314 and a second frame support 316. The frame supports 314, 316 serve for securely setting up the main frame 310, ideally without the latter tilting.

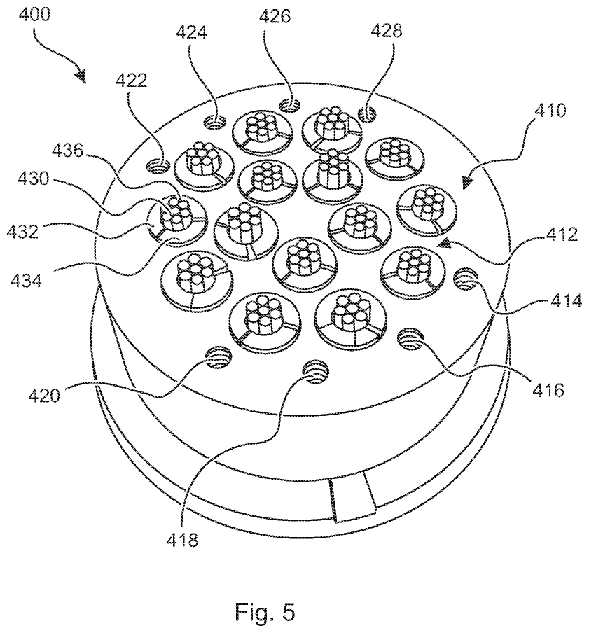

FIG. 5 shows a schematic three-dimensional view of an anchor plate having a plurality of tension members fastened thereto. The tension member fastening 400 comprises the anchor plate 410. A plurality of tension member openings 412 in which tension members are fastened with chock elements are disposed in the anchor plate 410. In a manner representative for all tension member openings 412 having tension members, the arrangement will be explained in an exemplary manner by means of the tension member 430. The tension member 430 extends through the tower to the tension member fastening 400 where said tension member 430 extends through a tension member opening 412 of the anchor plate 410. Apart from the tension member 430, a first chock element 432, a second chock element 434 and a third chock element 436 are disposed in the tension member opening 412. The chock elements 432, 434, 436 are configured in such a manner that said chock elements wedge the tension member 430 in the tension member opening 412 when the tension member 430 is under a tensile load, thus firmly holding said tension member 430 in the longitudinal direction thereof. The chock elements 432, 434, 436 are in particular configured for fixing the tension member 430 in the direction into the image plane. The chock elements 432, 434, 436 do not firmly hold the tension member 430 substantially in the direction out of the image plane.

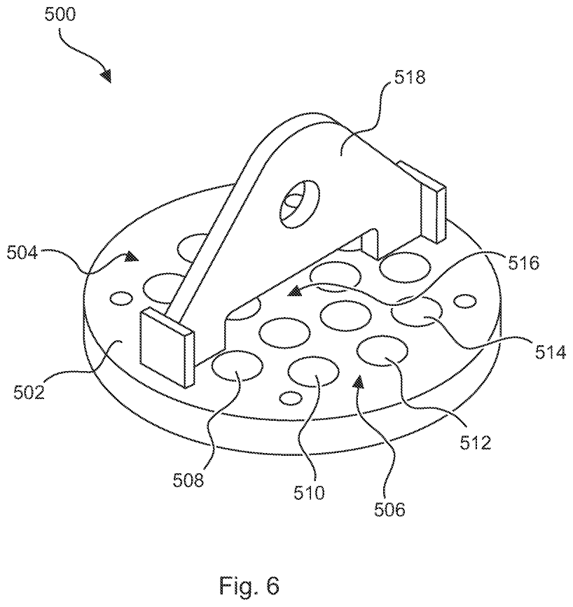

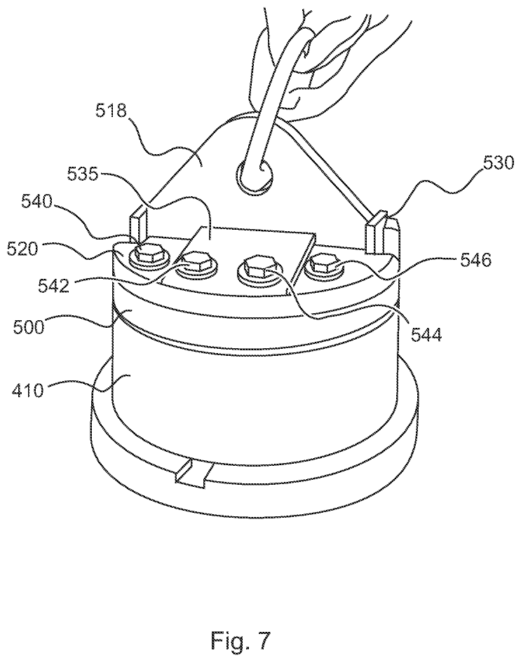

The anchor plate 410 moreover has the plate fastening openings 414-428. The plate fastening openings 414-428 are typically not present when originally installing the anchor plate 410 in the tower. The plate fastening openings 414-428 have been subsequently incorporated in the anchor plate 410 for the deconstruction of the tower. The plate fastening openings 414-428 serve for fastening a cover unit shown in FIG. 6 and FIG. 7, or a first cover element, respectively.

The cover element 500 shown in FIG. 6 is configured for disposal on the anchor plate 410 shown in FIG. 5. The first cover element 500 has a first cover plate 502. A bridging element 518 is diametrically disposed on the circular first cover plate 502. The bridging element 518 can be disposed on the first cover plate 502 by using welding technology, for example. The bridging element 518 on that side thereof that faces the first cover plate has a plate opening 516 so that an available height is created in a portion between the bridging element 518 and the first cover plate 502.

A plurality of cover openings are disposed in the first cover plate 502. As a result of the bridging element 518, a first plate flank 504 is created on the first side of the bridging element 518, and a second plate flank 506 is created on the other side of the bridging element 518. A first cover opening 508, a second cover opening 510, a third cover opening 512, and a fourth cover opening 514 are disposed in the second plate flank 506. The cover openings 510, 512, 514 serve inter alia for introducing a fastening element through the first cover plate 502, said fastening element extending to plate fastening openings 414-428 on an anchor plate 410.

The first cover element 500 is shown in the assembled state in FIG. 7. The first cover element 500 is disposed on the anchor plate 410. A second cover plate 520 is disposed on the first plate flank 504. The second cover plate 520 has a semi-circular geometry. The second cover plate circumferentially terminates conjointly with the first cover plate 502. Moreover, a third cover plate 530 is disposed on the second plate flank 506. A fourth cover plate 535 is disposed on the second cover plate 520 and the third cover plate 530. The fourth cover plate 535 on the second plate flank 506 extends from the second cover plate 520 to the third cover plate 530. The second cover plate 520 by way of a first fastening element 540 and a fourth fastening element 546 is fastened to the anchor plate 410. The fastening elements 540, 546 extend through passage openings of the second cover plate 520, through the cover openings of the first cover plate 502, to the threaded plate fastening openings in the anchor plate 410.

As a result of this fastening of the first cover plate 502, the second cover plate 520, the third cover plate 530 and the fourth cover plate 535, reliable fastening of the tension members 430 also takes place in a vertically upward direction on the anchor plate 410. The entire anchor plate 410 typically jumps upward when the tension members are cut. As the individual tension members however do not substantially jump out of the anchor plate, the device shown in FIG. 7 can be completely extracted from the tower with a crane. The removal of the cut tension members is simplified herewith, because the individual tension members do not have to be extracted or subsequently moved back to the original position thereof on the anchor plate 410, but can be easily extracted in one step.

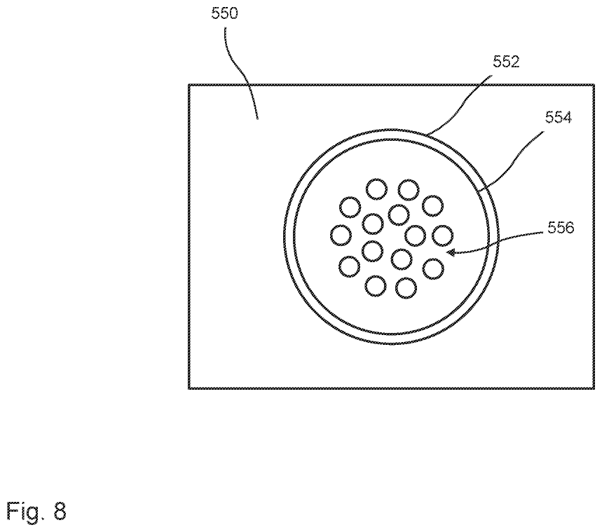

FIG. 8 shows a schematic two-dimensional view of a cable head disposed in the cellar of a concrete tower. Shown in particular is a cellar ceiling 550 of a concrete tower on which an annular collection container 552 for a cable head 554 is disposed. A plurality of tension members 556 are disposed and anchored in the cable head 554. When the concrete tower is accessible, the tension members 556 can be released by releasing the anchoring in the cable head 554. This can be performed in particular by disposing a flame cutter on the cable head 554 and subsequently burning and/or melting the cable head 554.

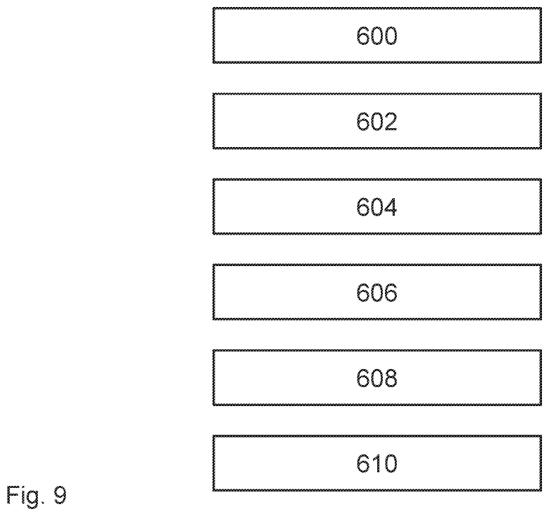

FIG. 9 shows a schematic method for cutting tensioned tension members of a concrete tower. In step 600, the main frame 310 is disposed within the cutting region 220 in the interior of the concrete tower 202. At least one of the tension members 212, 214, 216 is situated in the cutting region 220.

In step 602, the bar-shaped positioning element 330 is coupled to the main frame 310. In step 604, the cutter 340 is disposed on that end of the positioning element 330 that faces the cutting region. Steps 602 and 604 can also be carried out prior to step 600. It is particularly preferable for steps 602 and 604 to be carried out in advance. In step 606, the cutter 340 is positioned in such a manner that said cutter 340 has a predetermined spacing from one of the tension members 212, 214, 216. This predetermined spacing of the cutter 340 from one of the tension members 212, 214, 216 is in particular determined by the technology of the cutter. For example, the predetermined spacing can be determined by a burner flame. In step 608, a cover unit is disposed and fastened above the tension member openings 412 on the anchor plate 410 in the region of the tower head.

In step 610, the tension member 212, 214, 216 is cut with the cutter 340, for example in that a flame cutting process is carried out on the tension member 212, 214, 216 with the cutter 340.

### LIST OF REFERENCE SIGNS

100 Wind power installation
102 Tower
104 Nacelle
106 Rotor
108 Rotor blades
110 Spinner
202 Concrete tower
204 Tower wall
206 Tower opening
210 Tension unit
212 First tension member
214 Second tension member
216 Third tension member
220 Cutting region
222 Operating region
300 Cutting device
310 Main frame
312 Guide rail
314 First frame support
316 Second frame support
320 Processing carriage
321a Left first wheel
321b Right first wheel
322a Second wheel
323 Main body
324a Left leg
324b Right leg
325 Axle
330 Positioning element
340, 340′ Cutter
342 Burner flame
344 Roughing disk
350 Gas supply element
400 Tension member fastening
410 Anchor plate
412 Tension member openings
414 First plate fastening opening
416 Second plate fastening opening
418 Third plate fastening opening
420 Fourth plate fastening opening
422 Fifth plate fastening opening
424 Sixth plate fastening opening
426 Seventh plate fastening opening
428 Eighth plate fastening opening
430 Tension member
432 First chock element
434 Second chock element
436 Third chock element
500 First cover element
502 First cover plate
504 First plate flank
506 Second plate flank
508 First cover opening
510 Second cover opening
512 Third cover opening
514 Fourth cover opening
516 Plate opening
518 Bridging element
520 Second cover plate
530 Third cover plate
535 Fourth cover plate
540 First fastening element
542 Second fastening element
544 Third fastening element
546 Fourth fastening element
550 Cellar ceiling
552 Annular collection container
554 Cable head
556 Tension members

1. A method comprising:
cutting a plurality of tension members of a concrete tower while the plurality of tension members are in tension, the cutting comprising:
coupling a bar-shaped positioning element to a main frame;
positioning the positioning element in such a manner that a cut end of the positioning element that faces the concrete tower is disposed within a cutting region in an interior of the concrete tower, wherein at least one of the tension members of the plurality of tension members is situated within the cutting region;
disposing a cutter on the cut end of the positioning element;
positioning the cut end in such a manner that the cutter has a predetermined spacing from one tension member of the plurality of tension members; and
cutting the at least one tension member with the cutter.

2. The method as claimed in claim 1, wherein:
the main frame is disposed outside the concrete tower; or
the main frame is disposed completely or partially within the concrete tower.

3. The method as claimed in claim 1, wherein the positioning element extends from the cutting region to an operating region, wherein the operating region is located outside the concrete tower.

4. The method as claimed in claim 1, comprising:
disposing a processing carriage on the main frame;
wherein the processing carriage is disposed so as to be movable on the main frame, wherein the positioning element is coupled to the main frame by the processing carriage; and
wherein the positioning element in a relocation direction of the processing carriage is fixedly disposed on the processing carriage.

5. The method as claimed in claim 4, wherein:
the main frame has a guide rail; and
the processing carriage has two guiding elements that are disposed on an axle, wherein a spacing of insides of the guiding elements is greater than a width of the guide rail.

6. The method as claimed in claim 1, wherein:
cutter is a flame cutter or comprises a flame cutter;
at least one gas supply element is disposed on the flame cutter; and
the at least one gas supply element is fastened to the positioning element.

7. The method as claimed in claim 1, the cutter is a flame cutter, wherein the flame cutter is supplied a first gas by a first gas supply element, and supplied a second gas by a second gas supply element.

8. The method as claimed in claim 1, wherein:
the cutter is configured as a subtractive tool or comprises a subtractive tool; and
the cutter is disposed on the positioning element by a tool receptacle.

9. The method as claimed in claim 1, wherein:
the plurality of tension members have member ends in a region of the concrete tower that faces away from a tower base and are fixed by an anchor plate, wherein the anchor plate has vertically aligned tension member openings, and wherein the member ends are disposed in the tension member openings by chock elements in such a manner that said member ends are fixed in a direction of the tower base;
the method comprising:
disposing a cover above the tension member openings; and
fastening the cover to the anchor plate.

10. The method as claimed in claim 9, wherein:
the cover unit has a first cover element having a first cover plate, wherein a bridging element is disposed on the first cover plate in such a manner that an available height exists between the first cover plate and the bridging element, and the first cover plate and a second plate flank, wherein the bridging element is disposed between the first plate flank and the second plate flank;
a second cover plate is disposed on the first plate flank, and a third cover plate is disposed on the second plate flank;
the second cover plate and the third cover plate connected to the first cover plate; and
the second cover plate and the third cover plate are connected by a fourth cover plate that extends from the second cover plate to the third cover plate.

11. The method as claimed in claim 9, wherein:
the fastening of the cover to the anchor plate comprises incorporating at least one opening and incorporating a thread in the opening; and
the cover is fastened to the anchor plate.

12. The method as claimed in claim 3, wherein:
the operating region is situated in an operating space closed on at least three sides; or
the operating space is configured as a container, wherein a side of the container that faces the concrete tower at least partially closed or is configured to be closed.

13. The method as claimed in claim 3, the cutter is a flame cutter, wherein gas supplied to the flame cutter is disposed in at least one gas storage unit, and the at least one gas storage unit is situated within the operating region.

14. A cutting device for cutting tensioned tension members of a concrete tower of a wind power installation concrete tower, the cutting device comprising:
a main frame having a length that extends from a processing end to an operating end, wherein the processing end is configured to be disposed within the concrete tower of the wind power installation concrete tower, and the operating end is configured to be disposed outside the concrete tower at an operating region that is spaced apart from the concrete tower;
a bar-shaped positioning element coupled to the main frame; and
a cutter disposed on a cutting end of the positioning element that faces away from the operating end of the main frame.

15. The cutting device as claimed in claim 14, comprising:
a processing carriage disposed on the main frame and is guided in at least one portion adjacent to the operating end; and
wherein the positioning element, in a relocation direction of the processing carriage, is fixedly to the processing carriage.

16. The cutting device as claimed in claim 15, wherein:
the main frame has a guide rail; and
the processing carriage has first two first wheels disposed on a first axle, wherein a spacing of insides of the first wheels is greater than a width of the guide rail, and the processing carriage bears on the guide rail by the first axle.

17. The cutting device as claimed in claim 16, wherein the processing carriage has two second wheels disposed on a second axle.

18. The cutting device as claimed in claim 14, wherein:
the cutter is a flame cutter, the cutting device further including at least one gas supply element that is disposed on the flame cutter, and the gas supply element is fastened to the positioning element; and/or
the cutter is configured as a subtractive tool, and wherein the cutter is preferably is disposed on the positioning element.

19. (canceled)

20. The method as claimed in claim 1, wherein the concrete tower is a wind power installation concrete tower.

21. The method as claimed in claim 5, wherein the two guiding elements are wheels.
